(19) United States
(12) Patent Application Publication
(10) Pub. No.: US 2022/0414198 A1
(43) Pub. Date: Dec. 29, 2022

(54) SYSTEMS AND METHODS FOR SECURE FACE AUTHENTICATION

(71) Applicant: Pavel Sinha, Brossard (CA)

(72) Inventor: Pavel Sinha, Brossard (CA)

(21) Appl. No.: 17/848,286

(22) Filed: Jun. 23, 2022

Related U.S. Application Data
(60) Provisional application No. 63/238,069, filed on Aug. 27, 2021.
(60) Provisional application No. 63/215,387, filed on Jun. 25, 2021.

(51) Int. Cl. G06F 21/32; G06V 40/16; G06V 10/74; G06V 10/82

(52) U.S. Cl. CPC G06F 21/32; G06V 40/172; G06V 10/74; G06V 10/82

(57) ABSTRACT

Systems and methods for secure face authentication are provided. One such system is embodied as a first device for authenticating a user using facial recognition for a second device, the first device including a memory; and a processing circuitry coupled to the memory, the second device, and a camera, where the processing circuitry is configured to: receive a reference facial image of the user from the second device; receive a first facial image of the user from the camera; perform facial recognition using the first facial image and the reference facial image; and send an indication to the second device indicative of whether the first facial image was a match for the reference facial image; and where the first device is configured to operate without an operating system.

### CROSS-REFERENCE TO RELATED APPLICATION(S)

This application claims priority to and the benefit of U.S. Provisional Application No. 63/215,387 filed on Jun. 25, 2021, having Attorney Docket No. SINHA-1000P and entitled, “FACE AUTHENTICATION SYSTEM WITH SECURED COMMUNICATION BETWEEN CNN-PROCESSOR, BIOS AND APPLICATION SOFTWARE,” and U.S. Provisional Application No. 63/238,069 filed on Aug. 27, 2021, having Attorney Docket No. SINHA-1005P2 and entitled, “FACE AUTHENTICATION SYSTEM WITH SECURED COMMUNICATION BETWEEN CNN-PROCESSOR, BIOS AND APPLICATION SOFTWARE,” the entire content of each of which is incorporated herein by reference.

### FIELD

The subject matter described herein generally relates to face authentication, and more particularly, to systems and methods for secure face authentication.

### INTRODUCTION

Devices capable of performing face authentication such as smart-phones have become very popular in recent years. However, these devices (e.g., laptops, desktops, etc.) require an operating system (OS) running in the background for the face authentication software to function. The face authentication software generally runs on either a graphics processing unit (GPU) or a central processing unit (CPU) with full system software along with its supported device drivers running in the background. These computer systems are vulnerable to unauthorized attacks due to the huge software stack needed to run the face authentication software. A secured system might ideally include elimination of the need for such software stacks. Further, ideally, the face authentication system may need protection against “Replay Attacks” and all stored data may need to be protected with “Replay Protected Memory Block (RPMB).”

In the coming years, reports have indicated that approximately 74% of the workforce will be working from home as a result of the Covid-19 pandemic and subsequent changes in the workforce setting. This will be considered a major paradigm shift in the workforce. As a result, people with endpoint devices such as company issued laptops, cellphones, tablets, etc., will be operating from home more than in the past. These endpoint devices will now be operating using a home internet connection, typically through a WiFi router that is not as secure as a network for a secured company network infrastructure. No matter how secure the endpoint device is, a weak or unsecured internet connection increases the vulnerability of the endpoint device. This presents a unique problem and something many companies have been scrambling to solve in the past years since the pandemic in 2020.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In one aspect, the disclosure provides a first device for authenticating a user using facial recognition for a second device, the first device comprising: a memory; and a processing circuitry coupled to the memory, the second device, and a camera, wherein the processing circuitry is configured to: receive a reference facial image of the user from the second device; receive a first facial image of the user from the camera; perform facial recognition using the first facial image and the reference facial image; and send an indication to the second device indicative of whether the first facial image was a match for the reference facial image; and wherein the first device is configured to operate without an operating system.

In one aspect for the first device, the processing circuitry is configured to perform the facial recognition using the first facial image and the reference facial image independent of the second device.

In one aspect for the first device, the second device is inoperable for the user until the user is authenticated based on the indication.

In one aspect for the first device, the processing circuitry is configured to perform the facial recognition before a booting process of the second device.

In one aspect for the first device, the processing circuitry is configured to periodically perform the facial recognition after the booting process of the second device.

In one aspect for the first device, the first facial image comprises an image of the user in a raw Bayer format; and the processing circuitry is configured to perform the facial recognition using the first facial image and the reference facial image, both in the raw Bayer format.

In one aspect for the first device, the second device is at least one of: a laptop computer, a desktop computer, a tablet computer, an automobile, or a key fob for an automobile.

In one aspect for the first device, the processing circuitry comprises a convolution neural network (CNN) configured to perform the facial recognition.

In one aspect for the first device, the CNN is configured to be trained for facial recognition in an initial training mode; and the CNN is configured to perform the facial recognition in an inference mode following the training mode.

In one aspect for the first device, further comprising one or more tamper resistant features.

In one aspect for the first device, a system comprising: the first device of claim 1; and the second device of claim 1, wherein the second device comprises: a motherboard including a basic input/output system (BIOS) circuitry; and the camera; wherein the first device is integrated in the second device between the BIOS circuitry and the motherboard; wherein the processing circuitry of the first device is configured to: receive, via encrypted communications, the reference facial image of the user from the BIOS circuitry; and send, via encrypted communications, the indication to the BIOS circuitry indicative of whether the first facial image was a match for the reference facial image.

In one aspect for the system, wherein either of the first device or the BIOS circuitry determines whether the match was sufficient to authenticate the user.

In one aspect for the system, wherein the second device comprises an operating system; and wherein the first device is configured to operate independent of the operating system of the second device.

In one aspect, the disclosure provides a method for a first device to authenticate a user of a second device using facial recognition, comprising: operating the first device without an operating system; receiving a reference facial image of the user from the second device; receiving a first facial image of the user from a camera; performing facial recognition using the first facial image and the reference facial image; and sending an indication to the second device indicative of whether the first facial image was a match for the reference facial image.

In one aspect for the method, wherein the performing facial recognition using the first facial image and the reference facial image is performed independent of the second device.

In one aspect for the method, wherein the second device is inoperable for the user until the user is authenticated based on the indication.

In one aspect for the method, wherein the performing facial recognition using the first facial image and the reference facial image is performed before a booting process of the second device.

In one aspect for the method, further comprising periodically performing the facial recognition after the booting process of the second device.

In one aspect for the method, wherein the first facial image comprises an image of the user in a raw Bayer format; wherein the reference facial image comprises an image of the user in a raw Bayer format; and wherein the performing the facial recognition using the first facial image and the reference facial image comprises performing the facial recognition using the first facial image and the reference facial image, where both images are in the raw Bayer format.

In one aspect for the method, wherein the second device is at least one of: a laptop computer, a desktop computer, a tablet computer, an automobile, or a key fob for an automobile.

In one aspect for the method, wherein the first device comprises a convolution neural network (CNN) for performing the facial recognition.

In one aspect for the method, wherein the CNN is configured to be trained for facial recognition in an initial training mode; and wherein the CNN is configured to perform the facial recognition in an inference mode following the training mode.

In one aspect, the disclosure provides a computing device comprising: an operating system; a camera configured to capture a facial image of a user; and a secure facial recognition circuitry coupled to the camera and configured to perform facial recognition using the facial image and a reference facial image, wherein the facial recognition is performed independent from the operating system.

### BRIEF DESCRIPTION OF THE DRAWINGS

FIG. 1 shows a block diagram of a computing device including an integrated secure face authentication device in accordance with some aspects of the disclosure.

FIG. 2 shows a block diagram of a secure face authentication device including a convolutional neural network (CNN) processor in accordance with some aspects of the disclosure.

FIG. 3 shows a block diagram of an exemplary CNN processor that can be used in a secure face authentication device in accordance with some aspects of the disclosure.

FIG. 4 shows a block diagram of an exemplary CNN processor that can be used in a secure face authentication device in accordance with some aspects of the disclosure.

FIG. 5 is a block diagram of an example training system for a secure face authentication system in accordance with some aspects of the disclosure.

FIG. 6 is a flowchart illustrating a process for performing (offline) training of a secure face authentication system in accordance with some aspects of the disclosure.

FIG. 7 is a flowchart illustrating a process for performing facial recognition (inference mode) at a secure face authentication device in accordance with some aspects of the disclosure.

FIG. 8 is a flowchart illustrating a process for performing facial recognition at a secure face authentication device in accordance with some aspects of the disclosure.

FIG. 9 is a block diagram of a secure face authentication device in accordance with some aspects of the disclosure.

FIG. 10 is a block diagram of a secure face authentication system embodied as a computing device in accordance with some aspects of the disclosure.

FIG. 11 is a block diagram of a secure face authentication device in accordance with some aspects of the disclosure.

### DETAILED DESCRIPTION

Referring now to the drawings, systems and methods for securely performing face authentication are presented. One such system includes first device for authenticating a user using facial recognition for a second device, the first device including a memory and processing circuitry coupled to the memory, the second device, and a camera. In such case, the processing circuitry is configured to: receive a reference facial image of the user from the second device; receive a first facial image of the user from the camera; perform facial recognition using the first facial image and the reference facial image; and send an indication to the second device indicative of whether the first facial image was a match for the reference facial image; and wherein the first device is configured to operate without an operating system. In another aspect, a computing device includes an operating system, a camera configured to capture a facial image of a user, and a secure facial recognition circuitry coupled to the camera and configured to perform facial recognition using the facial image and a reference facial image, wherein the facial recognition is performed independent from the operating system.

In one aspect, embodiments described herein can be implemented using a hardware solution where a secured processing element (e.g., secure face authentication device), including an artificial intelligence (AI) processor (AI-Processor), is inserted on a cable disposed between the camera (used for facial recognition) and the mother board (e.g., primary circuit board for device upon which access will be granted once facial recognition is confirmed). The AI-Processor (e.g., implemented with a single chip or chip package) can perform the face authentication algorithm in hardware rather than in software. The face authentication can be performed on hardware without requiring any operating system (OS), device drivers or software stack to be running in the background. The processing element (e.g., secure face authentication device) may be configured at power-on from a secured and encrypted storage with a small amount of configuration data rather than instructions (e.g., sequential instructions) as compared to a traditional processor. The small configuration data may be stored securely (e.g., only in an encrypted form) as compared to storing a traditional AI algorithm instruction set.

In one aspect, all configuration data for the processing element including algorithm specific coefficients are encrypted in hardware and stored with Replay Protection Memory Block (RPMB) protection. The processing element may directly talk to the BIOS (e.g., of the second device, a computing device that needs user authentication) through a secured and encrypted protocol. These features will be discussed in greater detail below.

### Exemplary Systems

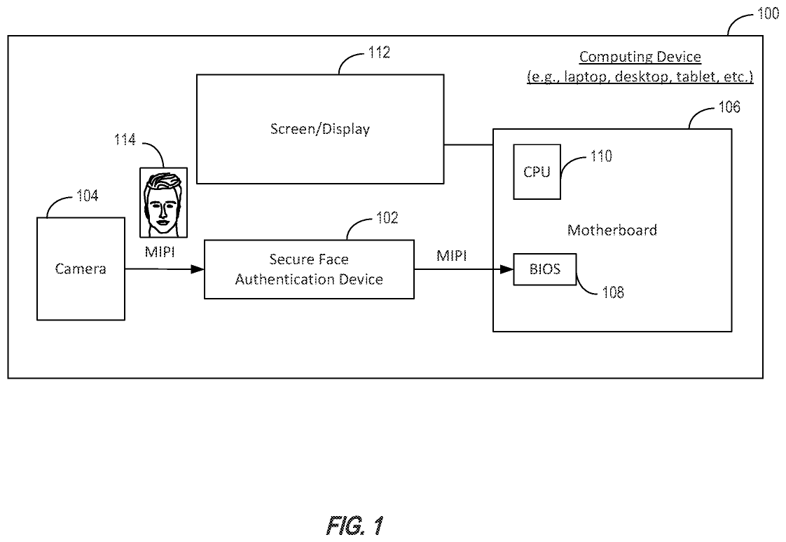

FIG. 1 shows a block diagram of a computing device 100 including an integrated secure face authentication device 102 in accordance with some aspects of the disclosure. The computing device 100 could be implemented as a laptop computer, a desktop computer, a tablet computer, an automobile computer, a key fob for an automobile, or any other computing device having a need to authenticate a user. In some of these applications, not all components illustrated would be included (e.g., screen/display might not be present). The computing device 100 further includes a camera 104, a motherboard 106 (which includes BIOS circuitry 108 and a central processing unit (CPU) 110, and a screen/display 112. The computing device 100 further includes other components common to these types of devices (as are known in the art), but not described here to focus on the major components involved. The secure face authentication device 102 is coupled between the camera 104 and the BIOS circuitry 108 over an industry standard camera bus (MIPI, the MIPI-CSI is a standard for connecting image sensors with image processing elements).

In operation, the secure face authentication device 102 can be pre-programmed (via secure communication, possibly via the BIOS) with one or more reference facial images for authorized users and any settings needed to perform facial recognition (e.g., coefficients for a neural network such as a convolution neural network (CNN)). If a user wants to use the computing device 100, the user needs to be authenticated. In one aspect, the computing device 100 is not operable (e.g., does not complete or begin boot up processes) unless the user is authenticated. To be authenticated, the user faces the camera 104 and allows it to capture a real-time facial image of the user 114. The secure face authentication device 102 receives the real-time user facial image 114 from the camera 104, and after having previously and securely authenticated the BIOS circuitry 108, performs facial recognition using the real-time user facial image 114 and the stored reference facial image(s) for the authorized users. If there is a sufficient match, then the user is authenticated, the computing device 100 boots, and the user may use the computing device 100. If the match is not sufficient, then the user is denied access and may try again. Aspects related to these features are described in greater detail below.

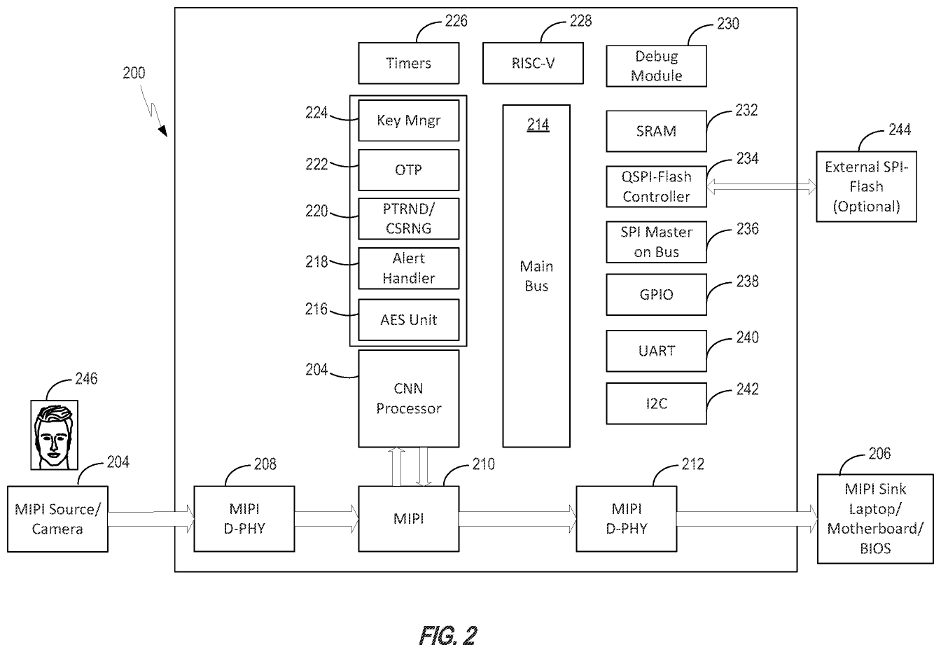

FIG. 2 shows a block diagram of a secure face authentication device 200 including a convolutional neural network (CNN) processor 202 in accordance with some aspects of the disclosure. The secure face authentication device 200 is coupled to a camera (e.g., MIPI source) 204 and a BIOS of a motherboard in a computer (e.g., MIPI sink) 206. The secure face authentication device 200 includes a first MIPI transceiver 208, a MIPI coupler 210, and a second MIPI transceiver 212. The first MIPI transceiver 208 is coupled directly with camera 204. The second MIPI transceiver 212 is coupled directly with the BIOS circuitry 206. The MIPI coupler 210 is coupled between the first MIPI transceiver 208 and the second MIPI transceiver 212, and to the CNN processor 204.

The secure face authentication device 200 further includes a main bus 214, an AES unit 216, an alert handler 218, a PTRND/ASRNG unit 220, an OTP unit 222, a key manager (Key Mngr) 224, timers 226, a RISC processor (e.g., RISC-V processor) 228, a debug module 230, a volatile memory (e.g., SRAM) 232, a flash controller (e.g., QSPI-flash controller) 234, an SPI master 236, a GPIO 238, a UART 240, and an I2C 242. The main bus 214 is coupled to each of these components and the CNN processor 204. The flash controller 234 is coupled to an external flash memory (e.g., external-SPI flash) 244, which is an optional component. The external flash memory 244 can be implemented on the same chip (e.g., within the same chip package) as the secure face authentication device 200.

In operation, the CNN processor 204 is configured to perform facial recognition using a real-time user facial image 246 and one or more stored user reference facial images. The operation of this component will be described in great detail below.

The AES unit (e.g., advanced encryption services unit) 216 is configured to provide various encryption or decryption services to processing components of the secure face authentication device 200, including, for example, the CNN processor 204 or the RISC processor 228.

The alert handler 218 is configured to determine whether various information from sensors indicate that someone is trying to hack/breach the secure face authentication device 200 (device implemented in chip package with one or more tamper sensors).

The PTRND/CSRNG unit 220 can provide random number generation to processing components of the secure face authentication device 200.

The OTP unit 222 (e.g., one-time programmable unit) is a relatively small memory that is programmable only once. It may be used to store unique identification information for the device like a serial number and/or a private encryption key.

The key manager 224 manages public and private keys, including storing them and making them available to the processing components.

The timers 226 are configured to time certain events based on requests/instructions from the processing components.

The RISC processor 228 is configured to handle small tasks (e.g., housekeeping tasks) for the device 200, including for example, receiving encrypted information, decrypting it, storing decrypted information, receiving user facial images, and reporting facial recognition results.

The debug module 230 may be used to debug device operation when the device or any of the processes or modules is not functioning correctly.

The volatile memory (e.g., SRAM) 232 can be used to store working data for operations of the processing components, including, for example, the CNN processor 204 or the RISC processor 228.

The flash controller (e.g., QSPI-flash controller) 234 can be used (e.g., as a controller and interface) to control and provide access to the external flash 244. Various information can be stored in the external flash 244 as needed by either of the processing components, or the other components of the device 200.

The SPI master (e.g., serial peripheral master) 236 can be used to control serial communications through any of the serial communications channels/interfaces, including the GPIO (e.g., general purpose input/output) 238, the UART (e.g., universal asynchronous receiver/transmitter) 240, and the I2C (e.g., inter-integrated circuit) 242.

In one aspect, the secure face authentication device 200 can be implemented in a chip and as a “bump” on a MIPI cable or integrated directly with camera sensor or on the PCB for the camera. The MIPI cable commonly extends between the motherboard 206/106 and the camera 204/104. These features can help secure the device as will described in greater detail below.

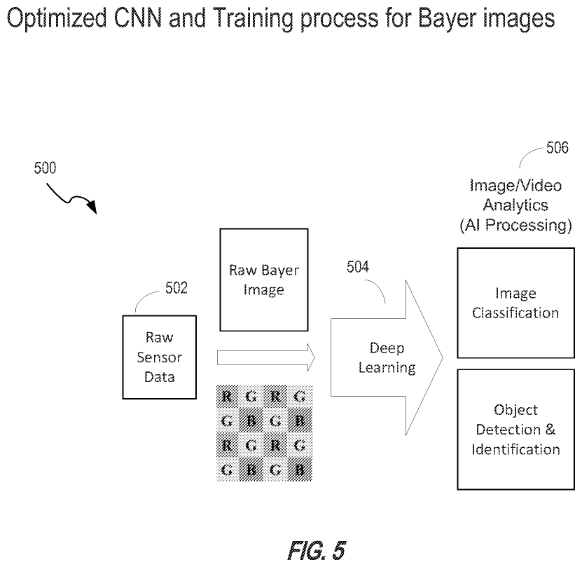

Applicant also has a patent pending device, described in U.S. patent application Ser. No. 17/105,293 having attorney docket number SINHA-1003, the entire content of which is incorporated herein by reference, that sniffs data transmitted between an image sensor and an image processing system to compute image analytics. This device provides a perfect low power interface, consuming as little power as possible. It mitigates data traffic between a co-processor and a processor. The co-processor could be internal or external to the chip. Examples of these systems are shown in FIGS. 2 and 5. In one aspect, the patent pending device could be used here as the secure face authentication device 200, or as a component thereof.

In one aspect, the interface from the camera 204 to the processing element (e.g., CNN processor) 204 for the secure face authentication device 200 is secured and has no backdoor entry points.

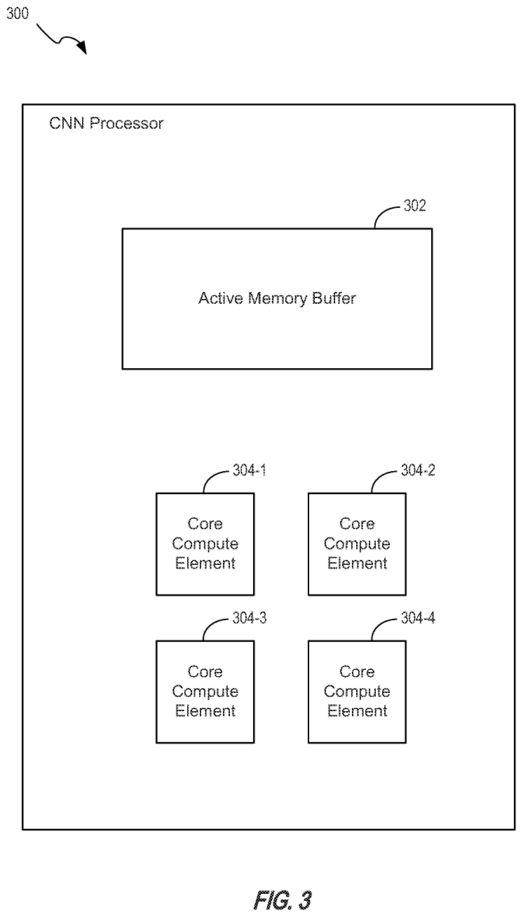

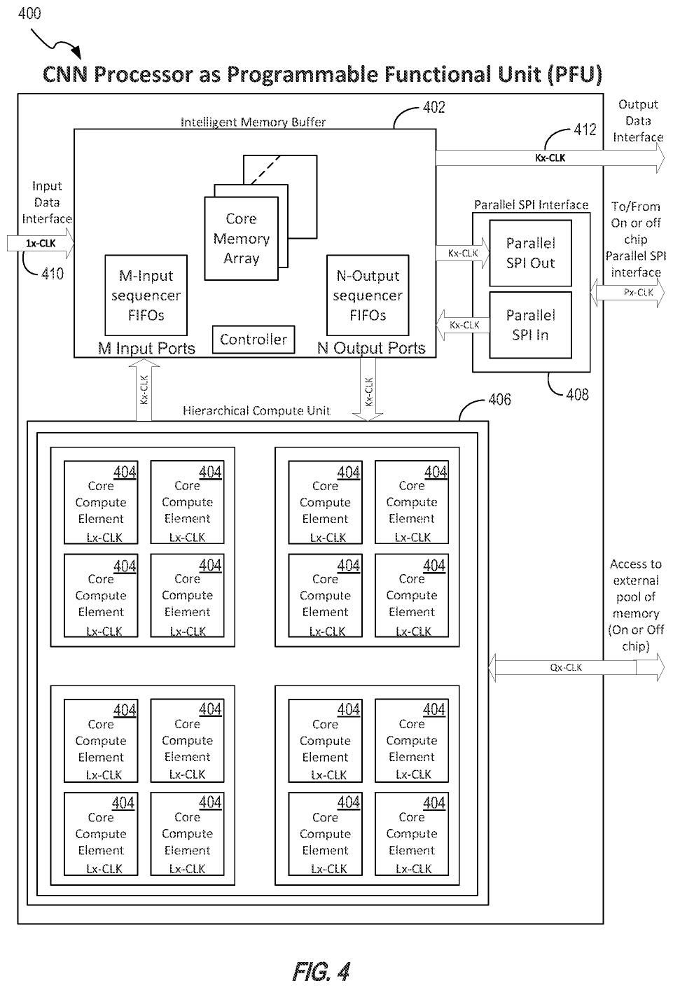

Applicant also has a patent pending AI-processor, described in U.S. patent application Ser. No. 16/933,859 having attorney docket number SINHA-1002, the entire content of which is incorporated herein by reference, that can be configured to run a CNN face detection algorithm in hardware without requiring any software driver or OS. This CNN processor 204 can be implemented with this AI-processor, the details of which are described below for FIGS. 3 and 4.

In one aspect, all internal data required by the CNN processing element 204 at power-up are stored: (a) on the AI-processor chip (e.g., at device 200 implemented as a chip), (b) off the chip in a secured device encrypted (e.g., in external flash 244), or (c) in on-chip storage where the AI-processor chip 200 and the storage device chip could be on a single package.

In one aspect, either of two implementations of the secure face authentication device 200 can be used. In a first case (Case I), the device 200 may be coupled with the BIOS using a secured protocol. In a second case (Case II), the device 200 and the flash chips (e.g., flash memory 244) are placed on the same package. In either of the two cases, the solution can be directly integrated on to the camera sensor, on the MIPI cable (e.g., MIPI Flex-cable), or on the PCB (e.g., PCB of the camera and/or the motherboard).

FIG. 3 shows a block diagram of an exemplary CNN processor 300 that can be used in a secure face authentication device in accordance with some aspects of the disclosure. The CNN processor 300 can be used within any of the secure face authentication devices described herein, including those shown in FIGS. 1 and 2. The CNN processor 300 (a configurable processor as shown here) includes an active memory buffer 302 and multiple core compute elements (304-1, 304-2, 304-3, 304-4, collectively referred to as 304), in accordance with some aspects of the disclosure. Each of the core compute elements (e.g., core compute circuitry elements) 304 can be configured to perform a CNN function in accordance with a preselected dataflow graph. A preselected dataflow graph can be derived from a preselected CNN to be implemented on the processor 300. The CNN functions can include one or more of a convolution function, a down-sampling (e.g., pooling) function, an up-sampling function, a native 1×1 convolution function, a native N×N convolution (e.g., 3×3 as will be described in greater detail herein) function, a configurable activation function through lookup table (LUT) value interpolation, an integration function, a local response normalization function, and a local batch normalization function. Each of the core compute elements can include an LSTM cell and/or inputs and outputs buffered by elastic shallow depth FIFOs. Additional details for the core compute elements 304 will be described below.

The active memory buffer 302 can be configured to move data between the core compute circuitry elements in accordance with the preselected dataflow graph. The active memory buffer 302 may include sufficient memory for these activities and to accommodate a large number of core compute elements.

A coupling fabric (not shown) exists between the core compute elements 304 and the active memory buffer 302 such that connections between the active memory buffer 302 and the core compute elements 304 can be established as needed. Similarly, the coupling fabric can enable connections between the core compute elements 304 as needed. The coupling fabric can be configured such that these connections are established in accordance with the preselected dataflow graph, corresponding to the preselected CNN to be implemented.

In FIG. 3, the configurable CNN processor 300 includes four core compute elements 304. In one aspect, the configurable CNN processor 300 can include more than, or less than, four core compute elements 304.

In one aspect, each of the core compute circuitry elements 304 can be configured to perform the CNN function in accordance with the preselected dataflow graph and without using an instruction set. In one aspect, at least two of the core compute circuitry elements 304 are configured to operate asynchronously from one another. In one aspect, the active memory buffer 302 is configured to operate asynchronously from one or more of the core compute circuitry elements 304. In one aspect, each of the core compute circuitry elements 304 is dedicated to performing the CNN function. For example, in one aspect, each of the core compute circuitry elements 304 can be specifically configured to compute only the CNN functions, and not, for example, general processing tasks typically performed by general purpose processors.

In one aspect, each of the core compute circuitry elements 304 can be configured, prior to a runtime of the configurable processor 300, to perform the CNN function. In one aspect, each of the core compute circuitry elements 304 is configured to compute a layer (e.g., a stage) of the CNN function. In one aspect, each of the core compute circuitry elements 304 is configured to compute an entire CNN.

In one aspect, the connections between the active memory buffer 302 and the core compute circuitry elements 304 are established during a compile time and fixed during a runtime of the configurable processor 300. Similarly, in one aspect, the connections between the core compute circuitry elements 304 are established during the compile time and fixed during the runtime.

Further details regarding the active memory buffer 302 and the core compute circuitry elements 304 are provided below.

In one aspect, each of the core compute elements 304 can act as a means for performing a CNN function in accordance with a preselected dataflow graph, as well as core compute elements 304. In one aspect, the active memory buffer 302 can act as a means for storing data, and for moving data between the plurality of means for performing the CNN function (e.g., core compute elements) via the means for storing data in accordance with the preselected dataflow graph, as well as the active memory buffers 302 and 600 described below. In one aspect, the coupling fabric (not shown in FIG. 3) can act as a means for establishing connections between the means for storing data (active memory buffer) and the plurality of means for performing the CNN function (core compute elements), in accordance with the preselected dataflow graph. This coupling fabric can also act as a means for establishing connections between the plurality of means for performing the CNN function (core compute elements), in accordance with the preselected dataflow graph.

FIG. 4 shows a block diagram of an exemplary CNN processor 400 that can be used in a secure face authentication device in accordance with some aspects of the disclosure. The CNN processor 400 can be used within any of the secure face authentication devices described herein, including those shown in FIGS. 1 and 2. The CNN processor 400 (embodied here as a programmable function unit (PFU)) includes an intelligent memory buffer (e.g., active memory buffer) 402, sixteen core compute elements 404 within a hierarchical compute unit 406, and a parallel SPI interface 408. In one aspect, the active memory buffer 402 and core compute elements (e.g., core compute circuitry elements) 404 can operate as described above for FIG. 3.

FIG. 4 can be viewed as a hierarchical representation of multiple core-compute elements/modules 404 with a single intelligent memory buffer 402, which collectively can be referred to as the PFU. Each of the core compute elements 404 can be accessible through a few read and write ports of the intelligent memory buffer 402. The PFU 400 further includes an input data interface 410 and an output data interface 412. Input data received via the input data interface 410 and output data sent via the output data interface 412 can directly interface with a read and write port, respectively, within the intelligent memory buffer 402. This can allow other PFU units to communicate with each other on a point-to-point basis via the read and write ports based on a transmitter and receiver configuration.

A read port (e.g., any one of the M input ports) and a write port (e.g., any one of the N output ports) can also be used to serialize and de-serialize data to be communicated over the serial to parallel interface 408, such as an SPI, with the other PFUs on a different chip. The SPI 408 can provide a relatively low power implementation of a communication channel between two PFUs across the chip boundary. In one aspect, PFU 400 is implemented using a single chip. Data sent via the parallel interface 408 within the PFU chip can be serialized and transmitted over a printed circuit board (PCB) and then parallelized once received at the destination chip (e.g., a second PFU). The serial link can be any kind of a serial link, from a simple SPI to a more complicated clock embedded link.

The PFU 400 may also include an interface with an external memory outside the PFU for the core compute elements to access a larger pool of memory. In a typical CNN, only a few layers need to access a large number of weights, specifically the fully connected layers. With only a few CNN layers needing to access a large number of weights, each PFU can be configured with only enough weight memory to store an average number of weights that are used in a convolution layer. As used herein, “weight memory” means memory of a core compute element used to store weights for processing/computing a CNN layer. Whenever a core compute element needs to access a larger amount of weight memory, it can fetch from the external larger pool of memory. However, the memory bandwidth for the external memory may be sufficient to support two core compute elements without any backpressure. Any larger number of core compute element accessing the larger pool of weight memory may result in reduced throughput.

When a particular convolution operation does not fit in a single core compute element due to a weight memory constraint, a convolution transformation can also be utilized to split the convolution across multiple core compute elements. This mechanism allows regular PFUs to be restricted to a relatively low amount of weight memory, and yet have the capability to access a larger number of weights either by accessing the external large pool of memory or by spreading the convolution across multiple core compute elements using convolution transformations.

In multiple aspects, the CNN processor 400 of FIG. 4 can be configured to perform facial recognition in a secure face authentication device.

FIG. 5 is a block diagram of an example training system 500 for a secure face authentication system in accordance with some aspects of the disclosure. In one aspect, the example training system 500 can be used to train an AI processing system, like a CNN processor such as any of the CNN processors described herein, to perform image classification and facial recognition. In one aspect, the example training system direct can be viewed as conversion image processing system 500 including a single deep learning component (e.g., CNN) 504 that generates image analytics 506 directly on raw Bayer image data 502 from a sensor, in accordance with some aspects of the disclosure. The CNN 504 directly processes raw Bayer camera sensor data 502 to produce image/video analysis 506. This process is quite different from a trivial approach of using one CNN to perform traditional image signal processing (ISP) function(s) and another CNN to perform the classification. In one aspect, the goal here is to have one CNN, about the same size as the original CNN for processing RGB image data, that classifies an input image by directly processing the corresponding raw Bayer sensor image. This CNN can efficiently skip the traditional ISP steps and add significant value to edge computing solutions where latency, battery-power, and computing power are constrained.

One challenge for using a CNN as a direct Bayer image processor is the lack of raw Bayer sensor images that are labeled and suitable for training. To address this issue, this disclosure proposes using a generative model to train on unlabeled raw Bayer images to synthesize raw Bayer images given an input RGB dataset. This disclosure then proposes using this trained generative model to generate a labeled image dataset in the raw Bayer format given a labeled RGB image dataset. This disclosure then proposes to use the labeled raw Bayer images to train the model (e.g., CNN) that directly processes raw Bayer image data to generate image analytics such as object detection and identification. The generative model may be used to convert any RGB dataset into a raw Bayer dataset. The CNN and generative models were tested on the popular ImageNet dataset and the results were very promising. The experimental setup is highly generic and has various applications from optimization for edge computing to autonomous driving. In one aspect, the sensor 502 can generate raw RGB image data, and the CNN 504 can directly process the raw RGB image data.

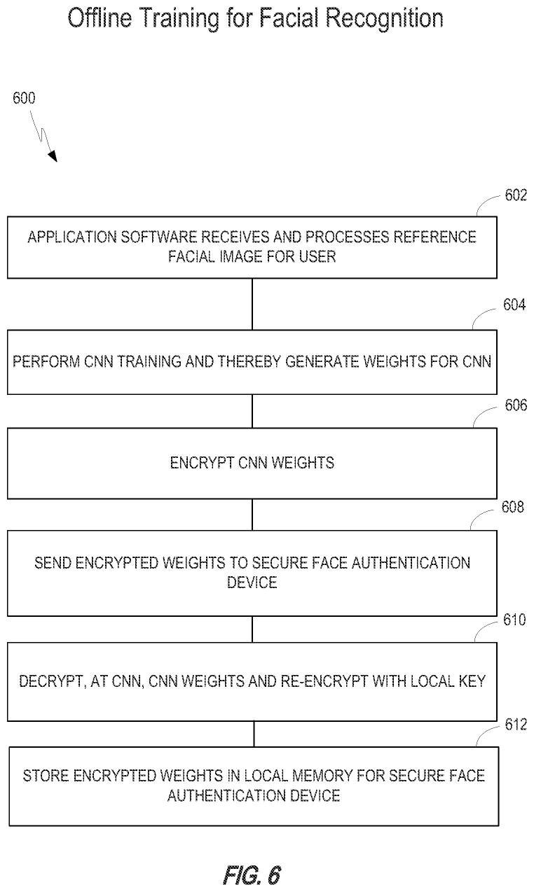

FIG. 6 is a flowchart illustrating a process 600 for performing (offline) training of a secure face authentication system in accordance with some aspects of the disclosure. In one aspect, the process 600 can be used in conjunction with the training system 500 of FIG. 5 to perform offline training and thereby train an AI processor, such as a CNN processor, to perform facial recognition. At block 602, the process (e.g., executed via application software running on a computing device) receives and processes one or more reference facial images for a user (e.g., an authorized user for the computing device where each authorized user has a unique reference facial image) or multiple users. In one aspect, an information technology (IT) professional such as a company IT administrator may run this application software in order to program the authorized users and seed the training for the AI of the secure facial authentication device.

In one aspect, offline training here can refer to the algorithm acquiring a reference image representing an authorized user, which the algorithm later uses during the testing phase to determine whether the test image is of the authorized person or not. This will involve offline processing of multiple images of the known (authorized) person(s). A feature vector represents a person. A feature vector is usually a vector of size 1×128 or 1×256. In other words, a person's identity is encoded into unique 128 or 256 words, irrespective of the input resolution, and each word is represented by 16 bits. This feature vector is computed offline (e.g., during offline training) when authorizing the appropriate person. Multiple feature vectors are aggregated from various images of the person of interest, generating a single feature vector. This single feature vector represents an authorized person. The stored feature vector is used during actual testing to detect whether the input image belongs to an authorized user. Hence this process will generally be done in a secured environment (by the IT professional/admin). The input image of the authorized person will be downloaded either to the BIOS or the secure facial authentication device. All data stored internally to the BIOS and the secure facial authentication device are encrypted and only accessible from within the chip (e.g., chip encompassing the secure facial authentication device), hence are securely stored.

At block 604, the process performs CNN (or other AI) training and generates the appropriate weights for the CNN. This action may be performed by the application software.

At block 606, the process encrypts the CNN weights. This action may be performed by the BIOS circuitry (e.g., BIOS circuitry 108 of FIG. 1).

At block 608, the process sends the encrypted weights to the secure facial authentication device (e.g., device 102 of FIG. 1 or device 200 of FIG. 2). This action may be performed by the BIOS circuitry (e.g., BIOS circuitry 108 of FIG. 1). The BIOS circuitry 108/206 and secure facial authentication device (e.g., device 102 of FIG. 1 or device 200 of FIG. 2) may communicate securely with one another after completing a mutual authentication process using a public and private key encryption system.

At block 610, the process decrypts the CNN weights at the secure facial authentication device and re-encrypts them with a local encryption key. This action may be performed at the secure facial authentication device 200 using one or more of the RISC processor 228, the AES unit 216, and key manager 224. In one aspect, this action may be performed by the CNN processor 204 where it can decrypt the weights and encrypt them again with its own internal key, for local storage.

At block 612, the process stores the encrypted weights in local memory for the secure facial authentication device. This action may be performed at the secure facial authentication device 200 using one or more of the SRAM 232 or external flash 244. In one aspect, this action may be performed by the CNN processor 204 where it can store the weights in a flash memory (or other suitable non-volatile memory), either on the same package, external or on chip storage.

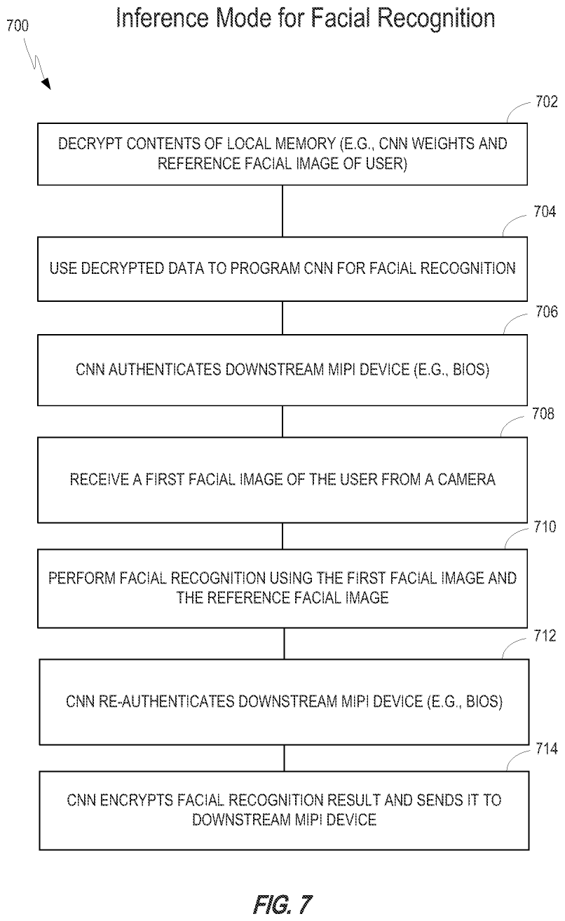

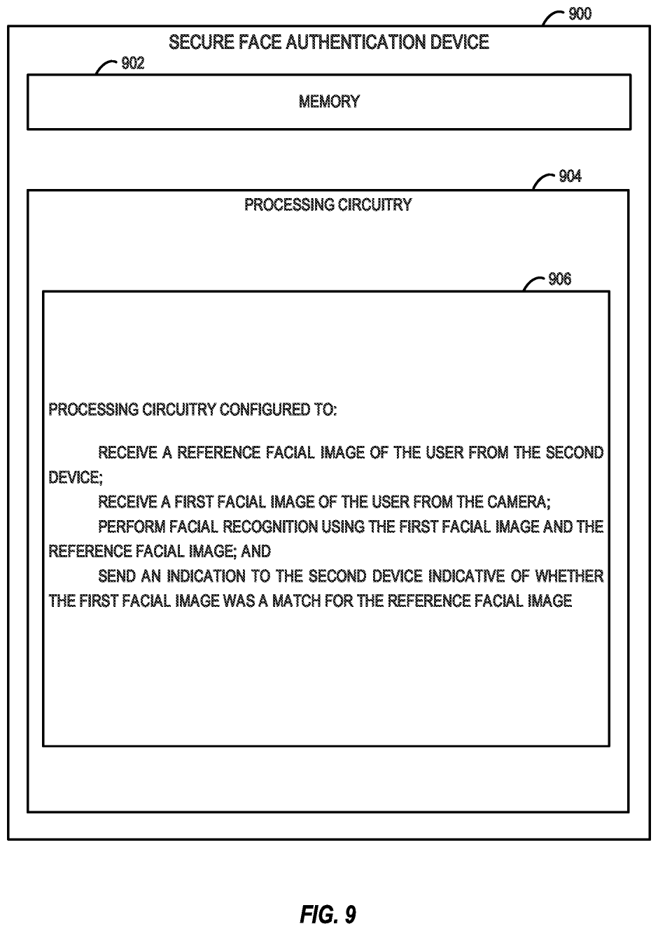

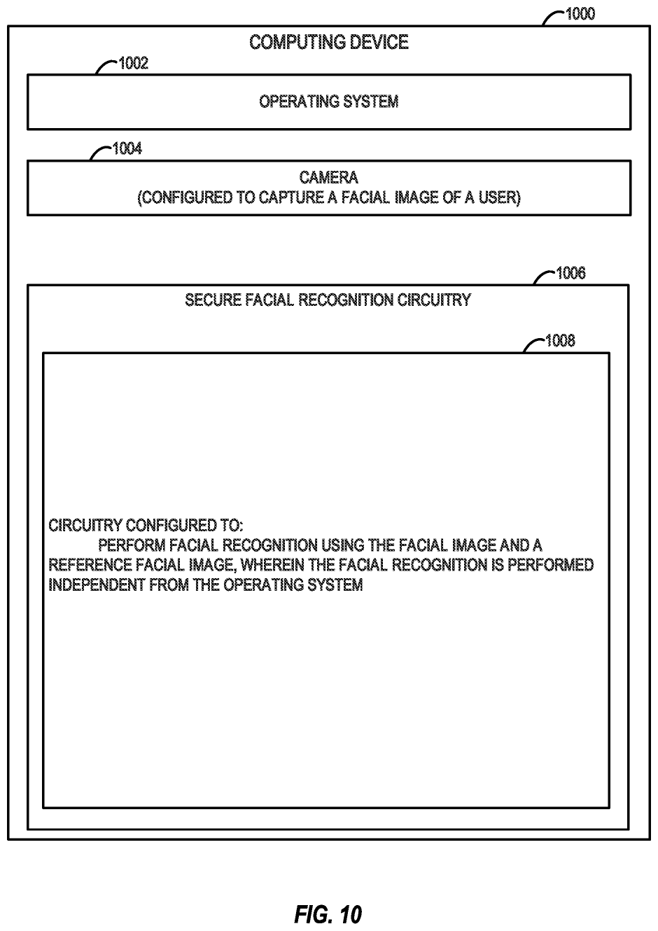

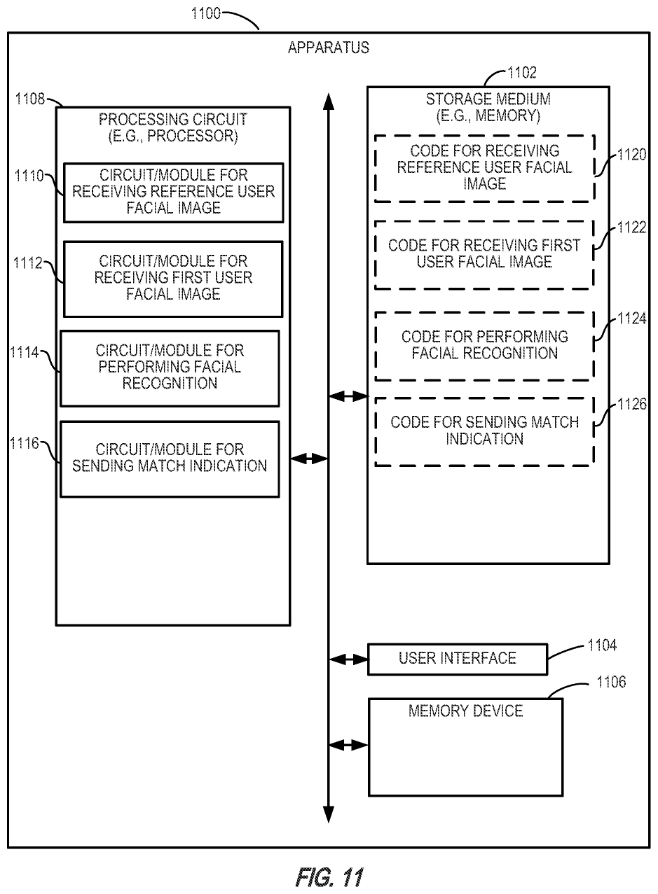

FIG. 7 is a flowchart illustrating a process 700 for performing facial recognition (inference mode) at a secure face authentication device in accordance with some aspects of the disclosure. In one aspect, process 700 can be used by any of the secure face authentication devices described herein, including, for example, secure face authentication device 102 in FIG. 1, device 200 in FIG. 2, device 900 of FIG. 9, device 1004 of FIG. 10, and device 1100 of FIG. 11.

At block 702, the process decrypts the contents of local memory. The local memory (e.g., SRAM 232 or external flash 244 of FIG. 2) may include CNN weights and one or more reference facial images of authorized users. In one aspect, this action may be performed (e.g., at power-on of the computing device 100) by the RISC processor 228 or FIG. 2 in conjunction with the AES unit 216, the key manager 224, the SRAM 232, and/or the external flash 244.

At block 704, the process uses the decrypted data to program the CNN processor (e.g., 204 in FIG. 2) to enable it to perform facial recognition. In one aspect, this action may be performed by the RISC processor 228 in conjunction with the CNN processor 204. The CNN processor 204 often includes its own memory, such as memory buffer 302 in FIG. 3, to store the decrypted data, including the CNN weights and reference facial images of authorized users.

At block 706, the process authenticates the downstream MIPI device. The downstream MIPI device can be the BIOS circuitry 206 in the computing device. The action may be performed by the RISC processor 228 and/or the CNN processor 204 (e.g., using a secure communication channel over any of the UART, SPI, I2C interfaces of FIG. 2). With the completion of blocks 702, 704 and 706, the CNN processor is now ready to receive data and process face authentication.

At block 708, the process receives a first facial image (e.g., 246 in FIG. 2) of a user from a camera. The user is a person who wants to use the device (e.g., wants to be authenticated). In one aspect, this action is performed by the RISC processor 228 in conjunction with the CNN processor 204, the camera 204, and the MIPI components (208, 210). The first facial image is a real-time facial image of the user captured by the camera.

At block 710, the process performs facial recognition using the first facial image and the reference facial image. In one aspect, this action is performed by the CNN processor 204 (e.g., using the weights learned in the prior training). The CNN processor can compare the processed first facial image with the reference facial image and a preselected tolerance/threshold (e.g., either a default pre-programmed threshold or one provided by the computing device via the BIOS) to decide upon an authentication successful or failure. The CNN processor can also leave the authentication logic to the downstream device and pass the net output of the CNN computation to the downstream device, whichever is desired by the system. In either case, data transmitted to the downstream device is considered as the net output from the CNN processor. It is noted here that other facial recognition algorithms could be used instead of using a CNN. For example, it is possible to instead get multiple frames and compute and average or do polling. In one aspect, the facial recognition can be performed using variants of the CNN algorithm. This could include using different CNN architectures. Another variant is to take the output of the CNN processor from multiple frames and take the average of the outputs of different frames before making the decision. Another variant would be to use traditional face recognition algorithms and not use a CNN. In addition to these variants of the CNN algorithm, the facial recognition of block 710 can use other suitable facial recognition known in the art.

At block 712, the process re-authenticates the downstream MIPI device (e.g., the BIOS circuitry 206 of FIG. 2). The action may be performed by the RISC processor 228 and/or the CNN processor 204.

At block 714, the process encrypts the facial recognition result and sends it to the downstream MIPI device (e.g., the BIOS circuitry 206 of FIG. 2). The action may be performed by the RISC processor 228 and/or the CNN processor 204. In one aspect, the result indicates whether there is a sufficient match between the first facial image and the reference facial image, based on a match threshold provided by the computing device via the BIOS, to authenticate the user. In another aspect, the result indicates a degree of correlation, possibly expressed as a percentage, between the first facial image and the reference facial image. In this case, the BIOS circuitry (or other secure circuitry within the computing device) can determine whether the match is sufficient to authenticate the user.

As a security check, between any of blocks 708 to 714, the CNN processor and/or RISC processor can re-initiate the actions of block 706, that is, to authenticate the downstream device: (a) at certain intervals periodically, and/or (b) if any system bus access gets initiated within the CNN processor.

In one aspect, any attempt to tamper with the secure face authentication device will cause the device to send an encrypted message to the downstream device indicating attempted tampering has occurred. In one aspect, this message will be sent periodically until the secure face authentication device is reset by the downstream device and only after reset will the secure face authentication device process data again for authentication.

### Security Features

Here the disclosure will try to further describe the hardware and software integration efforts to ensure secured communication with the secure face authentication device (e.g., device 200 in FIG. 2) as applied to face-authentication at power-on. This is to specify a framework that considers Replay Protection Memory Block (RPMB), i.e., replay protection, and prevent false authentication from hardware swapping/replacement of the CNN-Processor in a system.

In one aspect, the secure face authentication device 200 and external flash 244 are on separate silicon dies, but packaged together as a single chip. In one aspect, the configuration data needed for the CNN processor 204 can be stored in an external flash 244 which could be on a separate die than the secure face authentication device 200 but within the same packaging as the secure face authentication device 200. Thus, for all practical purposes, the secure face authentication device 200 can be considered as a single hardware chip. In one aspect, all CNN processor 204 configuration data is to be contained in the external flash 244.

As to hardware security on the secure face authentication device 200, the AES unit 216 provides a hardware encryption/decryption engine with true random number generator (e.g., from component 220). The OTP unit 222 can store information like a private key and/or a unique chip identification number such as a serial number. Because it is one time programmable, it is tamper proof or at least tamper resistant.

As to hardware communication on-chip for the secure face authentication device 200, the SPI master 236 can be configured to accept command-frame from the BIOS (host), where programming procedures, protocol, and other requirements can be determined in conjunction with BIOS manufacturers and/or manufacturers of computing devices that control develop their own BIOS.

Considering for a moment the security aspects of the overall face recognition processes, an application from the OS level can perform training on a face needed to be authenticated at power-on and generates configuration data for the CNN processor 204. This configuration data is sent to the CNN processor 204 from the application and may be stored in the flash module 244. In one aspect, the CNN processor 204 or the device 200 encrypts every bit of data before storing it in the external flash 244. In order to enforce RPMD, the encryption is performed using a “time-stamp,” which is unique every time it is generated. This unique time-stamp is stored in the OTP register of the CNN-Processor that retains data after power shutdown. At the same time, this unique time-stamp is also stored in the BIOS. At power-up, at least in one aspect, the secure face authentication device 200 needs to match the “time-stamp” data from the BIOS 206, its internal OTP register 222, and from the external flash 244 in order for it to declare system-integration maintained, and only then the CNN processor 204 performs the face authentication operation.

This also prevents replacement/tampering with the flash memory 244 content. In one aspect, the “time-stamp” data is written to the BIOS and the AI-Processor (e.g., CNN processor) each time when the reference image data is passed to the AI-Processor. In one aspect, this is not done on a regular basis at runtime. Thus, in this case, each time the user authentication data changes, a “time-stamp” is written to both BIOS and AI-Processor in a secure environment and can only be done in a secure authorized environment. This required update of the BIOS and the AI-Processor data. The timestamp ensures authenticated pairing of the CNN processor 204 configuration data stored in the flash memory 244, the CNN processor 204 and the BIOS 206. This ensures that tampering or replacement of the secure face authentication device 200 is prevented.

In one aspect, all communication to the BIOS, including the writing of the “time-stamp” information and passing of the generated face authentication output, i.e., the metadata, is to be done through the SPI bus of the secure face authentication device 200 using a shared public and private key protocol. The private key of the secure face authentication device 200 can be stored in the OTP register of the secure face authentication device 200.

In one aspect, this disclosure describes methods to secure from tampering the secure face authentication device 200, including swapping of the secure face authentication device 200. The “time-stamp” data could be stored in a trusted platform model (TPM) or other protected device to pair the secure face authentication device 200, BIOS 206 and/or the motherboard. In one aspect, for additional security purposes, all other IO pins of the chip package for the secure face authentication device 200 could be removed at the packaging of the silicon die including JTAG connectors.

### Additional Exemplary Systems

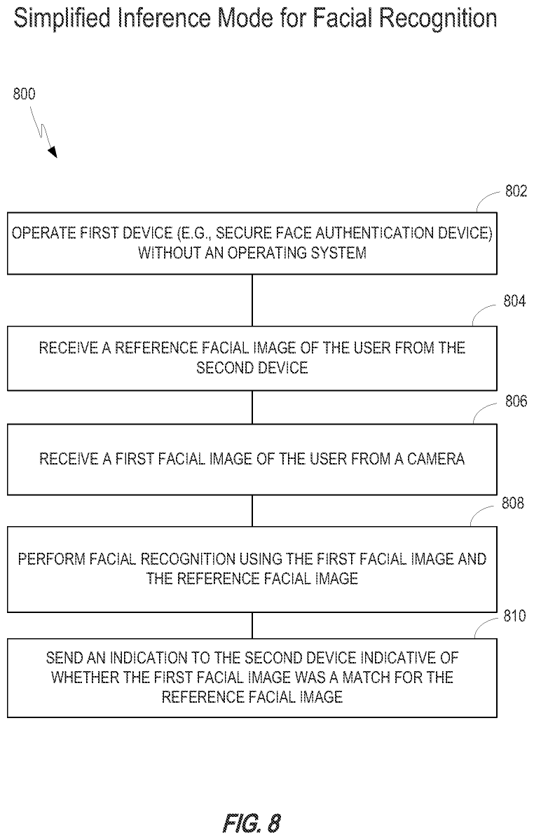

FIG. 8 is a flowchart illustrating a process 800 for performing facial recognition at a secure face authentication device in accordance with some aspects of the disclosure. In one aspect, process 800 can be used by any of the secure face authentication devices described herein, including, for example, secure face authentication device 102 in FIG. 1, device 200 in FIG. 2, device 900 of FIG. 9, device 1004 of FIG. 10, and device 1100 of FIG. 11.

At block 802, the process operates the first device without an operating system. The first device can be the secure face authentication device, and as noted above, operates without an operating system (e.g., as is used within a computing device such as a laptop, desktop, tablet, cell phone, etc.). By operating without the operating system, the secure face authentication device eliminates a point of entry that may be exploited by hackers trying to gain access (e.g., unauthorized access) to a second device (e.g., computing device). In contrast to the operating system, the secure face authentication device operates without an application programming interface or other means of reprogramming the device, and all communications and data involved with the device can be encrypted.

At block 804, the process receives a reference facial image of the user from the second device. As noted above, the second device can be a computing device such as a laptop, desktop, tablet, cell phone, etc.). In one aspect, the second device is the device on which the user wishes to be authenticated. The authentication is performed, at least in part, by the first device, as will be explained herein. In one aspect, the reference facial image of the user is received (e.g., during offline training) via encrypted secured communication between the first device and a BIOS circuitry of the second device, or another suitable computer that can be used for offline training. In one aspect, the action of block 804 is performed by the RISC processor 228 in conjunction with the CNN processor 204, the camera 204, and the MIPI components (208, 210).

At block 806, the process receives a first facial image of the user from a camera. In one aspect, the camera (e.g., camera 104 in FIG. 1) is a component of the second device (e.g., computing device 100 of FIG. 1) configured to capture photos or video, and specific photos for the purpose of user authentication. The first facial image of the user is a real-time photo of the user that includes a sufficient portion of the user's face as to be used for facial recognition. In one aspect, the computing device can prompt the user, before booting, to position the user's face in front of the camera in order to capture the first facial image. In one aspect, the action of block 806 is similar to that of block 708 of FIG. 7.

At block 808, the process performs facial recognition using the first facial image and the reference facial image. In one aspect, the CNN processor 204 of FIG. 2 (or other suitable CNN processors as described herein) can perform this action (e.g., using the weights learned in the prior training). As noted in detail above, the CNN processor 204 may be trained in an offline training procedure for image comparison/detection generally and more specifically for facial recognition. The CNN processor can compare the processed first facial image with the reference facial image and a preselected tolerance/threshold to decide upon whether the authentication was successful or not successful. The CNN Processor can also leave the authentication logic to the downstream device and pass the net output of the CNN computation to the downstream device, whichever is desired by the system. In either case, data transmitted to the downstream device is considered as the net output from the CNN processor. In one aspect, the action of block 808 is similar to that of block 710 of FIG. 7.

At block 810, the process sends an indication to the second device indicative of whether the first facial image was a match for the reference facial image. Similar to block 714 of FIG. 7, the process may encrypt the facial recognition result and send it to the downstream MIPI device (e.g., the BIOS circuitry 206 of FIG. 2). The action of block 810 may be performed by the RISC processor 228 and/or the CNN processor 204. In one aspect, the result/indication indicates whether there is a sufficient match between the first facial image and the reference facial image, based on a match threshold provided by the computing device via the BIOS, to authenticate the user. In another aspect, the result indicates a degree of correlation, possibly expressed as a percentage, between the first facial image and the reference facial image. In this case, the BIOS circuitry (or other secure circuitry within the computing device) can determine whether the match is sufficient to authenticate the user.

Various other features for the process of FIG. 8 and the secure face authentication devices described herein are contemplated. For example, in one aspect, the secure face authentication device (e.g., processing circuitry such as CNN processor 204) is configured to perform the facial recognition using the first facial image and the reference facial image independent of the second device (e.g., computing device 100).

In one aspect, the second device (e.g., computing device 100) is inoperable for the user until the user is authenticated based on the indication (e.g., of a facial match from the first device).

In one aspect, the secure face authentication device 200 (e.g., processing circuitry such as CNN processor 204) is configured to perform the facial recognition before a booting process of the second device.

In one aspect, the secure face authentication device 200 (e.g., processing circuitry such as CNN processor 204 and RISC processor 228) is configured to periodically perform the facial recognition after the booting process of the second device.

In one aspect, the first facial image includes an image of the user in a raw Bayer format, and the secure face authentication device 200 (e.g., processing circuitry such as CNN processor 204 and RISC processor 228) is configured to perform the facial recognition using the first facial image and the reference facial image, both in the raw Bayer format. In another aspect, the first facial image is in a RGB format and the secure face authentication device can be configured to perform the facial recognition using the first facial image and the reference facial image, both in the RGB format.

In one aspect, the second device a laptop computer, a desktop computer, a tablet computer, an automobile, a key fob for an automobile, some combination of these devices, or another computing device that needs secure authentication of a user.

In one aspect, the secure face authentication device 200 includes a convolution neural network (CNN) such as CNN processor 204 configured to perform the facial recognition. In such case, the CNN is configured to be trained for facial recognition in an initial training mode, and the CNN is configured to perform the facial recognition in an inference mode following the training mode.

In one aspect, the secure face authentication device 200 includes one or more tamper resistant features, such as are discussed above.

In one aspect, a system is contemplated including the first device (e.g., secure face authentication device) and a second device (e.g., computing device), where the second device includes a motherboard including a basic input/output system (BIOS) circuitry, and a camera, and where the first device is integrated in the second device between the BIOS circuitry and the motherboard (e.g., see FIG. 1 and FIG. 2). In such case, the processing circuitry of the first device can be configured to receive, via encrypted communications, the reference facial image of the user from the BIOS circuitry, and send, via encrypted communications, the indication to the BIOS circuitry indicative of whether the first facial image was a match for the reference facial image. In one aspect of this system, either of the first device or the BIOS circuitry determines whether the match was sufficient to authenticate the user. In one aspect of this system, the second device uses an operating system, and wherein the first device is configured to operate independent of the operating system of the second device.

In one aspect, the BIOS of the second device (e.g., computing device such as 100 in FIG. 1), and specifically drivers for the BIOS, is modified to allow for secure communications with the first device (e.g., secure face authentication device), offline training of the first device, and secure communication of the reference facial images for authorized users to the first device. In one such case, these modifications can involve adding capabilities to store the reference facial images and store encryption keys needed for secure communications with the first device. In one aspect for secure communications between the first device and the second device, each has its own private key and may exchange a public key. These keys may be used for encrypted communications and mutual authentication purposes.

FIG. 9 is a block diagram of a secure face authentication device 900 in accordance with some aspects of the disclosure. The secure face authentication device 900 (e.g., a first device for authenticating a user using facial recognition for a second device such as computing device 100 in FIG. 1) includes a memory 902 and processing circuitry 904. The processing circuitry is configured (906) to: receive a reference facial image of the user from the second device; receive a first facial image of the user from the camera; perform facial recognition using the first facial image and the reference facial image; and send an indication to the second device indicative of whether the first facial image was a match for the reference facial image. In one aspect, the secure face authentication device 900 can perform any of, or at least some of, the actions described in FIG. 8, the actions described in FIG. 7, or the various other actions described in the sections above for those figures. In one aspect, the secure face authentication device 900 can be implemented as device 102 in FIG. 1, device 200 in FIG. 2, or other such devices described herein.

FIG. 10 is a block diagram of a secure face authentication system 1000 embodied as a computing device in accordance with some aspects of the disclosure. The secure face authentication system 1000 (e.g., a computing device such as computing device 100 in FIG. 1) includes an operating system 1002, a camera 1004, and secure facial recognition circuitry 1006 (e.g., secure face authentication device such as device 102 in FIG. 1, device 200 in FIG. 2, or other such devices described herein). The secure facial recognition circuitry 1006 is coupled to the camera 1004 and configured (1008) to perform facial recognition using a facial image of the user (captured by the camera) and a reference facial image (for the user), wherein the facial recognition is performed independent from the operating system. In one aspect, the secure face authentication device 900 can perform any of, or at least some of, the actions described in FIG. 8, the actions described in FIG. 7, or the various other actions described in the sections above for those figures.

FIG. 11 is a block diagram of an apparatus (e.g., secure face authentication device) 1100 in accordance with some aspects of the disclosure. The apparatus 1100 includes a storage medium 1102, a user interface 1104, a memory device (e.g., a memory circuit) 1106, and a processing circuit 1108 (e.g., at least one processor). In various implementations, the user interface 1104 may include one or more of: a keypad, a display, a speaker, a microphone, a touchscreen display, of some other circuitry for receiving an input from or sending an output to a user. These components can be coupled to and/or placed in electrical communication with one another via a signaling bus or other suitable component, represented generally by the connection lines in FIG. 11. The signaling bus may include any number of interconnecting buses and bridges depending on the specific application of the processing circuit 1108 and the overall design constraints. The signaling bus links together various circuits such that each of the storage medium 1102, the user interface 1104, and the memory device 1106 are coupled to and/or in electrical communication with the processing circuit 1108. The signaling bus may also link various other circuits (not shown) such as timing sources, peripherals, voltage regulators, and power management circuits, which are well known in the art, and therefore, will not be described any further.

The memory device 1106 may represent one or more memory devices. In some implementations, the memory device 1106 and the storage medium 1102 are implemented as a common memory component. The memory device 1106 may also be used for storing data that is manipulated by the processing circuit 1108 or some other component of the apparatus 1100.

The storage medium 1102 may represent one or more computer-readable, machine-readable, and/or processor-readable devices for storing programming, such as processor executable code or instructions (e.g., software, firmware), electronic data, databases, or other digital information. The storage medium 1102 may also be used for storing data that is manipulated by the processing circuit 1108 when executing programming. The storage medium 1102 may be any available media that can be accessed by a general purpose or special purpose processor, including portable or fixed storage devices, optical storage devices, and various other mediums capable of storing, containing or carrying programming.

By way of example and not limitation, the storage medium 1102 may include a magnetic storage device (e.g., hard disk, floppy disk, magnetic strip), an optical disk (e.g., a compact disc (CD) or a digital versatile disc (DVD)), a smart card, a flash memory device (e.g., a card, a stick, a key drive, or a solid state drive (SSD)), a random access memory (RAM), a read only memory (ROM), a programmable ROM (PROM), an erasable PROM (EPROM), an electrically erasable PROM (EEPROM), a register, an OTP memory, a removable disk, and any other suitable medium for storing software and/or instructions that may be accessed and read by a computer. The storage medium 1102 may be embodied in an article of manufacture (e.g., a computer program product). By way of example, a computer program product may include a computer-readable medium in packaging materials. In view of the above, in some implementations, the storage medium 1102 may be a non-transitory (e.g., tangible) storage medium. For example, the storage medium 1102 may be a non-transitory computer-readable medium storing computer-executable code, including code to perform operations as described herein.

The storage medium 1102 may be coupled to the processing circuit 1108 such that the processing circuit 1108 can read information from, and write information to, the storage medium 1102. That is, the storage medium 1102 can be coupled to the processing circuit 1108 so that the storage medium 1102 is at least accessible by the processing circuit 1108, including examples where at least one storage medium is integral to the processing circuit 1108 and/or examples where at least one storage medium is separate from the processing circuit 1108 (e.g., resident in the apparatus 1100, external to the apparatus 1100, distributed across multiple entities, etc.).

Programming stored by the storage medium 1102, when executed by the processing circuit 1108, causes the processing circuit 1108 to perform one or more of the various functions and/or process operations described herein. For example, the storage medium 1102 may include operations configured for regulating operations at one or more hardware blocks of the processing circuit 1108.

The processing circuit 1108 is generally adapted for processing, including the execution of such programming stored on the storage medium 1102. As used herein, the terms “code” or “programming” shall be construed broadly to include without limitation instructions, instruction sets, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 1108 is arranged to obtain, process and/or send data, control data access and storage, issue commands, and control other desired operations. The processing circuit 1108 may include circuitry configured to implement desired programming provided by appropriate media in at least one example. For example, the processing circuit 1108 may be implemented as one or more processors, one or more controllers, and/or other structure configured to execute executable programming. Examples of the processing circuit 1108 may include a general purpose processor, a graphics processing unit (GPU), a digital signal processor (DSP), an application-specific integrated circuit (ASIC for example including a RISC processor and a CNN processor), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1108 may also be implemented as a combination of computing components, such as a combination of a GPU and a microprocessor, a DSP and a microprocessor, a number of microprocessors, one or more microprocessors in conjunction with a DSP core, an ASIC and a microprocessor, or any other number of varying configurations. These examples of the processing circuit 1108 are for illustration and other suitable configurations within the scope of the disclosure are also contemplated.

According to one or more aspects of the disclosure, the processing circuit 1108 may be adapted to perform any or all of the features, processes, functions, operations and/or routines for any or all of the apparatuses described herein. For example, the processing circuit 1108 may be configured to perform any of the steps, functions, and/or processes described with respect to FIGS. 6-10. As used herein, the term “adapted” in relation to the processing circuit 1108 may refer to the processing circuit 1108 being one or more of configured, employed, implemented, and/or programmed to perform a particular process, function, operation and/or routine according to various features described herein.

The processing circuit 1108 may be a specialized processor, such as a GPU or an application-specific integrated circuit (ASIC) that serves as a means for (e.g., structure for) carrying out any one of the operations described in conjunction with FIGS. 6-10. The processing circuit 1108 serves as one example of a means for performing the functions of any of the circuits/modules contained therein. In various implementations, the processing circuit 1108 may provide and/or incorporate, at least in part, the functionality described above for the secure face authentication devices of FIGS. 6-10.

According to at least one example of the apparatus 1100, the processing circuit 1108 may include one or more of a circuit/module for receiving a reference facial image of the user from a second device (e.g., computing device 100 of FIG. 1) 1110, a circuit/module for receiving a first facial image of a user from a camera (e.g., camera 104 of FIG. 1 or camera 204 of FIG. 2) 1112, a circuit/module (e.g., CNN processor 202 of FIG. 2) for performing facial recognition using the first facial image and the reference facial image 1114, a circuit/module for sending an indication to the second device indicative of whether the first facial image was a match for the reference facial image 1116, and/or other suitable circuit modules. In various implementations, these circuits/modules may provide and/or incorporate, at least in part, the functionality described above for FIGS. 6-10.

As mentioned above, programming stored by the storage medium 1102, when executed by the processing circuit 1108, causes the processing circuit 1108 to perform one or more of the various functions and/or process operations described herein. For example, the programming may cause the processing circuit 1108 to perform the various functions, steps, and/or processes described herein with respect to FIGS. 5, 6, and/or 10 in various implementations. As shown in FIG. 11, the storage medium 1102 may include one or more of code for receiving a reference facial image of the user from the second device 1120, code for receiving a first facial image of the user from a camera 1122, code for performing facial recognition using the first facial image and the reference facial image 1124, code for sending an indication to the second device indicative of whether the first facial image was a match for the reference facial image 1126, and/or other suitable circuit modules.

Features for Addressing Work from Home Challenges

As to the problem noted above in the introduction regarding work from home security challenges, aspects of this disclosure present a unique solution to address this problem. By using a secure face authentication device (e.g., secured hardware chip) that performs face authentication and is integrated with the system BIOS (as is described above), the disclosed device (e.g., implemented in a chip) provides a secured form of face authentication on any endpoint device. This can be used as a secured endpoint device to constantly face authenticate and identify the presence of an authorized user or multiple users. This allows the secure face authentication device to identify and block any unauthorized transaction while the user is not present in front of the endpoint device or not using it. This provides a security boost to the endpoint security system by identifying the true physical presence of an authorized endpoint user as opposed to an automated intrusion software (e.g., such as a virus or other malware scanning software running on the device).

As a result, the endpoint devices can be made even more secure using continuous face authentication in the background, with the user not even realizing it and identifying most or all unauthorized transactions and blocking them. The initial solution of face authenticating a user before booting of a computing device presented above is augmented with this additional feature, of performing face authentication after booting, possibly periodically or based on certain events. Thereby not only can the disclosed secure face authentication device be used for a secured power-on face authentication system, but it can also be used periodically to validate the presence of a true physical authorized user (TPAU) in front of the endpoint device (e.g., computing device), thereby securing the endpoint device under different situations including, where the network itself is not secured.

In one aspect, the secure face authentication device can be referred to as FaceChip, and, as discussed above, it can operate without needing any OS or software stack, thereby making it a highly secured solution. In one aspect, the secure face authentication device, implemented as a single chip face authentication device, does not have any back doors, and all its internal data is fully encrypted in hardware and stored within the single chip. In one aspect, the secure face authentication device also supports the root-of-trust protocol making it highly secure.

In one aspect, the secure face authentication device may be used to identify whether an authorized user is using the laptop far beyond just an initial secured log-in. This will enable identification and block unauthorized intrusion into the endpoint device.

As to the features of the secure face authentication device, it can block and identify malware activity and unintentional breaches when the user is not in front of the device. In one aspect, the secure face authentication device, implemented as FaceChip, can be highly secured and no OS or software stack need be used for it to function. In one aspect, the secure face authentication device can be implemented using a single chip that performs face initial (boot up) and then periodic authentication. In one aspect, the secure face authentication device can be implemented using entirely in hardware and all its internal data is fully encrypted in the hardware, such that no backdoors exist. In one aspect, and as noted above, the secure face authentication device can also support the root-of-trust protocol making it highly secure.

In one aspect, the information of the user's physical presence in front of an endpoint device is effectively utilized in a secured manner to stop any malicious activity that might happen in his absence. The secured hardware enables the identification of malicious activity easily in the absence of the user. Additionally, hackers cannot breach this secured hardware root-of-trust device, unlike other approaches using a universal serial bus (USB) webcam or any unsecured device attached to an endpoint device.

In one aspect, these techniques may involve identifying the physical presence of an endpoint device user or users in a secured way and then using this information to identify any malicious activity on the endpoint device in the absence of the user. Among other things, this may provide additional details of the true physical presence or absence of the user in a secured way.

### Additional Aspects

The examples set forth herein are provided to illustrate certain concepts of the disclosure. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

One or more of the components, steps, features and/or functions illustrated in above may be rearranged and/or combined into a single component, step, feature or function or embodied in several components, steps, or functions. Additional elements, components, steps, and/or functions may also be added without departing from novel features disclosed herein. The apparatus, devices, and/or components illustrated above may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example of a storage medium is coupled to the processor such that the processor can read information from, and write information to, the storage medium. In the alternative, the storage medium may be integral to the processor.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “I” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise, a set of elements may include one or more elements. In addition, terminology of the form “at least one of a, b, or c” or “a, b, c, or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated.

What is claimed is:

1. A first device for authenticating a user using facial recognition for a second device, the first device comprising:
a memory; and
a processing circuitry coupled to the memory, the second device, and a camera, wherein the processing circuitry is configured to:
receive a reference facial image of the user from the second device;
receive a first facial image of the user from the camera;
perform facial recognition using the first facial image and the reference facial image; and
send an indication to the second device indicative of whether the first facial image was a match for the reference facial image; and
wherein the first device is configured to operate without an operating system.

2. The first device of claim 1, wherein the processing circuitry is configured to perform the facial recognition using the first facial image and the reference facial image independent of the second device.

3. The first device of claim 1, wherein the second device is inoperable for the user until the user is authenticated based on the indication.

4. The first device of claim 1, wherein the processing circuitry is configured to perform the facial recognition before a booting process of the second device.

5. The first device of claim 4, wherein the processing circuitry is configured to periodically perform the facial recognition after the booting process of the second device.

6. The first device of claim 1:
wherein the first facial image comprises an image of the user in a raw Bayer format; and
wherein the processing circuitry is configured to perform the facial recognition using the first facial image and the reference facial image, both in the raw Bayer format.

7. The first device of claim 1, wherein the second device is at least one of: a laptop computer, a desktop computer, a tablet computer, an automobile, or a key fob for an automobile.

8. The first device of claim 1, wherein the processing circuitry comprises a convolution neural network (CNN) configured to perform the facial recognition.

9. The first device of claim 8:
wherein the CNN is configured to be trained for facial recognition in an initial training mode; and
wherein the CNN is configured to perform the facial recognition in an inference mode following the training mode.

10. The first device of claim 1, further comprising one or more tamper resistant features.

11. A system comprising:
the first device of claim 1; and
the second device of claim 1, wherein the second device comprises:
a motherboard including a basic input/output system (BIOS) circuitry; and
the camera;
wherein the first device is integrated in the second device between the BIOS circuitry and the motherboard;
wherein the processing circuitry of the first device is configured to:
receive, via encrypted communications, the reference facial image of the user from the BIOS circuitry; and
send, via encrypted communications, the indication to the BIOS circuitry indicative of whether the first facial image was a match for the reference facial image.

12. The system of claim 11:
wherein either of the first device or the BIOS circuitry determines whether the match was sufficient to authenticate the user.

13. The system of claim 11:
wherein the second device comprises an operating system; and
wherein the first device is configured to operate independent of the operating system of the second device.

14. A method for a first device to authenticate a user of a second device using facial recognition, comprising:
operating the first device without an operating system;
receiving a reference facial image of the user from the second device;
receiving a first facial image of the user from a camera;
performing facial recognition using the first facial image and the reference facial image; and
sending an indication to the second device indicative of whether the first facial image was a match for the reference facial image.

15. The method of claim 14, wherein the performing facial recognition using the first facial image and the reference facial image is performed independent of the second device.

16. The method of claim 14, wherein the second device is inoperable for the user until the user is authenticated based on the indication.

17. The method of claim 14, wherein the performing facial recognition using the first facial image and the reference facial image is performed before a booting process of the second device.

18. The method of claim 17, further comprising periodically performing the facial recognition after the booting process of the second device.

19. The method of claim 14:
wherein the first facial image comprises an image of the user in a raw Bayer format;
wherein the reference facial image comprises an image of the user in a raw Bayer format; and
wherein the performing the facial recognition using the first facial image and the reference facial image comprises performing the facial recognition using the first facial image and the reference facial image, where both images are in the raw Bayer format.

20. The method of claim 14, wherein the second device is at least one of: a laptop computer, a desktop computer, a tablet computer, an automobile, or a key fob for an automobile.

21. The method of claim 14, wherein the first device comprises a convolution neural network (CNN) for performing the facial recognition.

22. The method of claim 21:
wherein the CNN is configured to be trained for facial recognition in an initial training mode; and
wherein the CNN is configured to perform the facial recognition in an inference mode following the training mode.

23. A computing device comprising:
an operating system;
a camera configured to capture a facial image of a user; and
a secure facial recognition circuitry coupled to the camera and configured to perform facial recognition using the facial image and a reference facial image, wherein the facial recognition is performed independent from the operating system.
